(19) United States
(12) Patent Application Publication
(10) Pub. No.: US 2017/0161806 A1
(43) Pub. Date: Jun. 8, 2017

(54) A SOCIAL E-COMMERCE SYSTEM AND SERVER FOR PRICE-ADJUSTED ITEM PURCHASER AGGREGATION

(71) Applicant: ALPHATISE HOLDINGS PTY LTD, New South Wales (AU)

(72) Inventor: Paul PEARSON, New South Wales (AU)

(21) Appl. No.: 15/321,306

(22) PCT Filed: Jul. 3, 2015
(86) PCT No.: PCT/AU2015/050376

§ 371 Date: Dec. 22, 2016

(30) Foreign Application Priority Data
Jul. 4, 2014 (AU) 2014902572
Aug. 1, 2014 (AU) 2014902988

(51) Int. Cl. G06Q 30/06; G06Q 30/02

(52) U.S. Cl. CPC G06Q 30/0605; G06Q 30/0222; G06Q 30/0603

(57) ABSTRACT

A system, server, and computer implemented method for adjusted price item purchaser aggregation is provided. The server for adjusted price item purchaser aggregation has a processor, which upon execution of computer program code stored in a memory device of the server is configured to receive, via a data network, item identification data representing an item and transmit, via the data network, the item identification data to a plurality of client computing devices; receive, via the data network, adjusted price request data representing a plurality of adjusted price requests for adjusted price amounts for the item or discounts from the plurality of client computing devices; and transmit, via the data network, adjusted priced item price offer data representing an adjusted offer price for the item.

### FIELD OF THE INVENTION

The present invention relates to social ecommerce and in particular to a system and server for collecting customer buying demand based on desired discount level or price point as well as additional customer data and subsequent offering and sharing of retail store discounts and prices for goods and services from selected merchants.

### BACKGROUND

In today's e-commerce landscape there are a number of categories of e-commerce platforms including discount group buying sites (such as Groupon, Living Social etc), e-commerce marketplaces, seller consolidation sites (such as Connect Furniture), online auction sites such as E-Bay) and straight e-commerce sites (such as Amazon.com). According to many existing discount group-buying sites, e-commerce providers negotiate adjusted pricing for goods and services where-after the goods and services are offered on an e-commerce platform at the adjusted pricing. The availability of such goods and services is often dependent on a minimum threshold of prospective purchasers signing up to a deal.

However, such existing arrangements suffer from several disadvantages. Specifically, deals are decided by the e-commerce providers, which may result in deals, which are few and far between, or deals, which are not related to market demand. It would be advantageous for an e-commerce system wherein end users, using the e-commerce system, may arrange the discounting of user nominated goods and services.

Furthermore, such existing e-commerce platforms offer adjusted prices when a certain threshold of prospective purchasers is met. However, these existing e-commerce platforms fail to take into account the actual number of prospective purchasers or the desired discount or price point. It would be advantageous for an e-commerce system that would offer price-adjusted goods and services in accordance with the number of prospective purchasers, and/or the desired discount or price point.

Furthermore, such existing e-commerce platforms advertise price-adjusted goods and services to specific prospective purchasers such as those prospective purchasers who have opted in to receive notifications only. However, such existing e-commerce platforms fail to take into account other prospective purchasers who may have similar interests in these products and services and fail to allow for the offering of such products and services to social relations of the specific prospective purchasers.

As such, a need therefore exists for a “user driven” price adjusting e-commerce platform.

Any discussion of the background art throughout the specification should in no way be considered as an admission that such background art is prior art nor that such background art is widely known or forms part of the common general knowledge in the field in Australia or worldwide.

### SUMMARY OF THE INVENTION

It is an object of the present invention to overcome or ameliorate at least one or more of the disadvantages of the prior art, or to provide a useful alternative.

Aspects of the invention as disclosed below seek to provide a social e-commerce system and server for offering, sharing and accepting retail store discounts and goods and services prices and discounted item purchaser aggregation.

According to one particular aspect, there is provided a system for purchaser aggregation, the system comprising a data network adapted for transmitting digital data; a server operably coupled to the data network; and a plurality of client computing devices in operable communication with the server across the data network; wherein, in use the server is adapted for receiving, via the data network, item identification data representing an item, the item identification data comprising at least item price data representing a price for the item; the server is adapted for transmitting, via the data network, to the plurality of client computing devices, the item identification data; the server is adapted for receiving, via the data network, adjusted price or discount request data representing a plurality of adjusted price requests a discount or specific amount for the item from the plurality of client computing devices; and the server is adapted for transmitting, via the data network, to the plurality of client computing devices, adjusted priced item price offer data representing an adjusted offer price or discount for the item.

It should be noted that the item price data representing a discount or specific price for the item may, in a particular arrangement, represent a discount percentage on the price of the item. In further arrangements, the item price data representing a price for the item may be a higher value than, say, the recommended retail price or the price normally on offer in the store, in exchange for an additional benefit or advantage to the purchaser for example guaranteed delivery within a specified time frame (eg, overnight, within 2 days, etc) or other benefit.

In this manner, the system is advantageously adapted to allow for the dissemination of product and service data so as to aggregate potential customers in anticipation of providing discounted or price-adjusted products and services to those potential customers.

The server may be adapted for calculating the price-adjusted item price offer data in accordance with the price-adjusted price request data. In this manner, the server calculates the adjusted price amount offered to prospective customers in accordance with the requests received from the prospective customers. Alternatively, the server may be adapted to receive via the network interface, the price-adjusted item price data. In this manner, a supplier, retailer or the like may configure the adjusted price or discount amount when pushing offers to prospective customers.

The server may be further adapted for transmitting, via the data network, to the plurality of client computing devices, catalogue data representing a catalogue of items. The catalogue data may comprise brand categories or goods and services classification catalogues or retail brands and retail stores. In this manner, prospective customers may browse for goods and services available for potential purchase or discounting in accordance with brand categories, or goods and services categories. Alternatively, the prospective customer may indicate that they are willing to pay a higher price than the price normally offered in exchange for additional benefit or advantage such as delivery within a specified time frame or to secure a difficult to source item.

The server may be further adapted to select the catalogue data, in accordance with a user specific data associated with a client computing device. In this manner, the server is able to serve more relevant catalogue items or stores to specific users.

In one manner, the user specific data may comprise location data such that the server is able to send catalogue data comprising retail outlets, goods and services or available discount offers within the proximity of the retail outlet, goods or services to the user.

Yet further, the user specific data may comprise social network data. In this manner, the server may send catalogue data to the user, where the catalogue data may have been configured in accordance with social relationships, such as, for example, providing goods and services items to a user in accordance with the preferences of the user's friends on a social network or any other group of friends/acquaintances/associates that might have the same or similar purchasing aspirations and desires.

The server may be further adapted for receiving, via the data network, user generated item identification data representing the item. In this manner, as opposed to having to use the catalogue to identify items, the user may identify the item directly.

The user generated item identification data may comprise at least one keyword. Alternatively, the user generated item identification data may comprise image data. In this manner, as opposed to having to input, using a keyboard or the like, the item identification data, the user may use an image capture device (e.g. camera) of their mobile communication device to capture an image of the item.

As a result, the server may be further adapted to identify the item in accordance with text recognition techniques, such as by identifying text within the image data. Alternatively, the server may be further adapted to identify the item in accordance with image recognition techniques as would be appreciated by the skilled addressee.

The user generated item identification data may comprise social network interaction data.

The server may be further adapted to request, via the data network, the item identification data in accordance with the user generated item identification data.

Yet further, the server may be adapted to syndicate, via the data network, the discounted or price-adjusted request data. In this manner, other users of the system may be notified of users request for a discounted or adjusted price. In this manner, a large number of potential customers may be attracted for the item.

The server may be adapted to syndicate, via the data network, the discounted or adjusted price request data using a social network, such that the user's friends on a social network receive notification of the user's discounted or adjusted price request.

Each of the plurality of client computing devices is adapted to receive, via user interface, the discounted or adjusted price request data allowing users to nominate their discounted or adjusted price requests.

The user interface may be adapted to display a control operable by a user for varying the discounted or adjusted price request. Furthermore, each of the plurality of client computing devices may be adapted to display, using a display device, discounted or adjusted price offer probability or likelihood data representing a probability or likelihood of an offer being made by the seller at the discounted or adjusted price requested. The discounted or adjusted price offer probability data may be calculated in accordance with the discounted or adjusted price request. In further arrangements, the likelihood of an offer being made at a particular price may be influenced by the number of requests received from users of the system to buy that item at a common or similar price.

In this manner, by varying the amount of the discounted or adjusted price requested, the user may be able to view, in substantial real time, the probability of receiving an offer from the relevant supplier.

In other arrangements, the discounted or adjusted price offer probability data is calculated in accordance with historical discounted item or adjusted priced item price offer data, the number of the plurality of discounted or adjusted price requests and the like, that is, past offers made by the retailer/supplier may affect the indicated likelihood of success of a particular offer. For example, if the requested price is the same or within, say, 5%, of the price at which an offer had been previously made to another user, the likelihood of the user receiving an offer to purchase the item at the requested price may be high (e.g. >80%). Alternatively, if the requested price is significantly lower than previously offered purchase prices, the likelihood of the user receiving an offer at the requested price may be very low. For example, using the above example, if offers to purchase the Samsung television for $800 had previously been made by the supplier, then new requests to purchase the item at the same price or higher may be very good. Alternatively, a request to purchase the item for $700 may have very little chance of being accepted.

In particular arrangements, the indication provided to the user may initially be evaluated within particular preset limits (for example requests for discounts of up to 10% of the recommended purchase price may have a high likelihood of being successful ranging to where requests for discounts greater than, say, 25% may have very low probability of being accepted). Once an established history has been acquired of numerous requests and/or offers, the likelihood of success of a request may be determined by a learning algorithm, such as, for example an artificial neural network, Bayesian algorithm or the like.

The adjusted priced item price data may comprise identification data uniquely identifying the discounted or price-adjusted item price, the identification data adapted for use in redeeming the discounted or price-adjusted item price.

The identification data may comprise scannable identification data, for example, barcode data, such as 1-D and 2-D barcodes or QR codes.

The server may be further adapted for receiving, via the data network, location data representing a location of a client computing device and discounting or adjusting a price in accordance with the price-adjusted item price offer data. In this manner, as opposed to having to use a barcode or the like for the purposes of redeeming an offer, the system is adapted to take into account the user's location so as to allow the redemption of an offer should the user's location coincide substantially with the location of the retail outlet.

In particular arrangements, the price-adjusted request data is lower price request data representing a plurality of requests for a lower (discounted) price for the item in question. In this way, the user can request a discounted price in relation to, for example, the recommended retail price of the item in question.

In alternative arrangements, the price-adjusted request data is higher price request data representing a plurality of higher price requests. In this way, the user can indicate that he or she is willing to pay a premium price on top of the recommended retail price, for example, in order to, for example, obtain the item more quickly. This feature is particularly useful in relation to items that are in high demand.

According to another aspect, there is provided a server for price-adjusted item purchaser aggregation, the server comprising a processor for processing digital data; a memory device for storing digital data including computer program code, the memory device being operably coupled to the processor; and a network interface for transmitting data across a data network, the network interface being operably coupled to the processor wherein, in use, the processor is controlled by the computer program code to receive, via the data network, item identification data representing an item, the item identification data comprising at least item price data representing a price for the item; transmit, via the data network, to a plurality of client computing devices, the item identification data; receive, via the data network, price-adjusted request data representing a plurality of price-adjusted requests for discount amounts for the item from the plurality of client computing devices; and transmit, via the data network, to the plurality of client computing devices, price-adjusted item price offer data representing a price-adjusted offer price for the item.

Preferably, the processor is further controlled by the computer program code to calculate the price-adjusted item price offer data in accordance with the price-adjusted request data.

Preferably, the processor is further controlled by the computer program code to receive, via the network interface, the price-adjusted item price offer data.

Preferably, the processor is further controlled by the computer program code to transmit, via the data network, to the plurality of client computing devices, catalogue data representing a catalogue of items.

Preferably, the catalogue data comprises brand categories.

Preferably, the catalogue data comprises goods and services classification catalogues.

Preferably, the processor is further controlled by the computer program code to select the catalogue data in accordance with a user specific data associated with a client computing device.

Preferably, the user specific data comprises location data.

Preferably, the user specific data comprises social network data.

Preferably, the processor is further controlled by the computer program code to receive, via the data network, user generated item identification data representing the item.

Preferably, the user generated item identification data comprises at least one keyword.

Preferably, the user generated item identification data comprises image data.

Preferably, the processor is further controlled by the computer program code to identify the item in accordance with a text recognition technique.

Preferably, the processor is further controlled by the computer program code to identify the item in accordance with an image recognition technique.

Preferably, the user generated item identification data comprises social network interaction data.

Preferably, the processor is further controlled by the computer program code to request, via the data network, the item identification data in accordance with the user generated item identification data.

Preferably, the processor is further controlled by the computer program code to syndicate, via the data network, the price-adjusted request data.

Preferably, the processor is further controlled by the computer program code to syndicate, via the data network, the price-adjusted request data using a social network.

Preferably, the processor is further controlled by the computer program code to calculate price-adjusted offer probability data representing a probability of the offer of the price-adjusted request.

Preferably, the price-adjusted offer probability data is calculated in accordance with the price-adjusted request.

Preferably, the price-adjusted offer probability data is calculated in accordance with historical price-adjusted item price offer data.

Preferably, the price-adjusted offer probability data is calculated in accordance with a number of the plurality of price-adjusted requests.

Preferably, the price-adjusted item price data comprises identification data uniquely identifying the price-adjusted item price, the identification data adapted for use in redeeming the price-adjusted item price.

Preferably, the identification data comprises scannable identification data.

Preferably, the scannable identification data comprises barcode data.

Preferably, the barcode data comprises at least one of 1-D and 2-D barcode data, or QR code data.

Preferably, the server is further adapted for receiving, via the data network, location data representing a location of a client computing device and discounting a price in accordance with the adjusted priced item price offer data.

Preferably, the price-adjusted request data is lower price request data representing a plurality of lower price requests.

Preferably, the price-adjusted request data is higher price request data representing a plurality of higher price requests.

According to an additional aspect, there is provided a computer-implemented method carried out by the server according to the aspect described above when the computer program code stored in the memory device of the server is executed by the processor of the server.

According to a further aspect, there is provided a computer-implemented method for purchaser aggregation, the method comprising: receiving, by a server via a data network, item identification data representing an item, the item identification data comprising at least item price data representing a price for the item; transmitting, by the server via the data network, to a plurality of client computing devices, the item identification data; receiving, by the sever via the data network, price-adjusted request data representing a plurality of price-adjusted requests for discount amounts for the item from the plurality of client computing devices; and transmitting, by the server via the data network, to the plurality of client computing devices, price-adjusted item price offer data representing a price-adjusted offer price for the item.

Preferably, the method comprises calculating, by the server, the price-adjusted item price offer data in accordance with the price-adjusted request data.

Preferably, the method comprises receiving, by the sever via the network interface, the price-adjusted item price offer data.

Preferably, the method comprises transmitting, by the server via the data network, to the plurality of client computing devices, catalogue data representing a catalogue of items.

Preferably, the catalogue data comprises brand categories.

Preferably, the catalogue data comprises goods and services classification catalogues.

Preferably, the method comprises selecting, by the server, the catalogue data in accordance with a user specific data associated with a client computing device.

Preferably, the user specific data comprises location data.

Preferably, the user specific data comprises social network data.

Preferably, the method comprises receiving, by the server via the data network, user generated item identification data representing the item.

Preferably, the user generated item identification data comprises at least one keyword.

Preferably, the user generated item identification data comprises image data.

Preferably, the method comprises identifying, by the server, the item in accordance with a text recognition technique.

Preferably, the method comprises identifying, by the server, the item in accordance with an image recognition technique.

Preferably, the user generated item identification data comprises social network interaction data.

Preferably, the method comprises requesting, by the server via the data network, the item identification data in accordance with the user generated item identification data.

Preferably, the method comprises syndicating, by the server via the data network, the price-adjusted request data.

Preferably, the method comprises syndicating, by the server via the data network, the price-adjusted request data using a social network.

Preferably, the method comprises calculating price-adjusted offer probability data representing a probability of the offer of the price-adjusted request.

Preferably, the price-adjusted offer probability data is calculated in accordance with the price-adjusted request.

Preferably, the price-adjusted offer probability data is calculated in accordance with historical price-adjusted item price offer data.

Preferably, the price-adjusted offer probability data is calculated in accordance with a number of the plurality of price-adjusted requests.

Preferably, the price-adjusted item price data comprises identification data uniquely identifying the price-adjusted item price, the identification data adapted for use in redeeming the price-adjusted item price.

Preferably, the identification data comprises scannable identification data.

Preferably, the scannable identification data comprises barcode data.

Preferably, the barcode data comprises at least one of 1-D and 2-D barcode data, or QR code data.

Preferably, the method comprises receiving, by the server via the data network, location data representing a location of a client computing device and discounting a price in accordance with the adjusted priced item price offer data.

Preferably, the price-adjusted request data is lower price request data representing a plurality of lower price requests.

Preferably, the price-adjusted request data is higher price request data representing a plurality of higher price requests.

According to another aspect of the invention there is provided a computer-implemented method for purchaser aggregation, comprising: maintaining a database containing item records of a plurality of items available for purchase from one or more item providers, each item record comprising item identification data including at least an item description, item offer price data, and identifying information of an associated item provider; receiving, by a server via a data network, at least one item request from a user via a client computing device of the user, the request comprising at least identifying information of a requested item, and an item price request; the server accessing the database to identify matching item records corresponding with the requested item; in the event that at least one matching item record is identified, the server transmitting, via the data network, a request notification to a client device of the item provider identified in the item record; the server subsequently receiving, via the data network, an acceptance of the request from the item provider via the client device of the item provider; and the server transmitting, via the data network, an acceptance notification to the client computing device of the user.

In another aspect of the invention, there is provided a server system comprising: a processor; a database, accessible by the processor, adapted to contain item records of a plurality of items available for purchase from one or more item providers, each item record comprising item identification data including at least an item description, item offer price data, and identifying information of an associated item provider; a memory operatively associated with the processor; and a network interface operatively associated within the processor and providing access by the processor to a data network, wherein the memory comprises data and program instructions executed by the processor so as to cause the server system to execute a method comprising: receiving, via the data network, at least one item request from a user via a client computing device of the user, the request comprising at least identifying information of a requested item, and an item price request; accessing the database to identify matching item records corresponding with the requested item; in the event that at least one matching item record is identified, transmitting, via the data network, a request notification to a client device of the item provider identified in the item record; subsequently receiving, via the data network, an acceptance of the request from the item provider via the client device of the item provider; and transmitting, via the data network, an acceptance notification to the client computing device of the user.

Item records within the database may be created in response to requests from the one or more item providers, who are advantageously willing to offer items as discounted prices in response to item requests of users. Alternatively or additionally, item records may be created in response to item requests of users, for example by the server retrieving from one or more third-party sources, via the data network, item identification data corresponding with identifying information in an item request. The server may further be configured to receive item search requests from users, and to retrieve from the one or more third-party sources, via the data network, item identification data corresponding with the search requests.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a system for price-adjusted item purchaser aggregation in accordance with an embodiment of the present invention;

FIG. 2 shows a computing device which may take the form of a server, client computing device or the like as substantially described in FIG. 1 in accordance with an embodiment of the present invention;

FIGS. 3 to 8 show exemplary graphical user interfaces displayed by the client computing devices of FIG. 1 in aggregating price-adjusted item purchasers.

### DESCRIPTION OF EMBODIMENTS

It should be noted in the following description that like or the same reference numerals in different embodiments denote the same or similar features.

### System 100 of Computing Devices

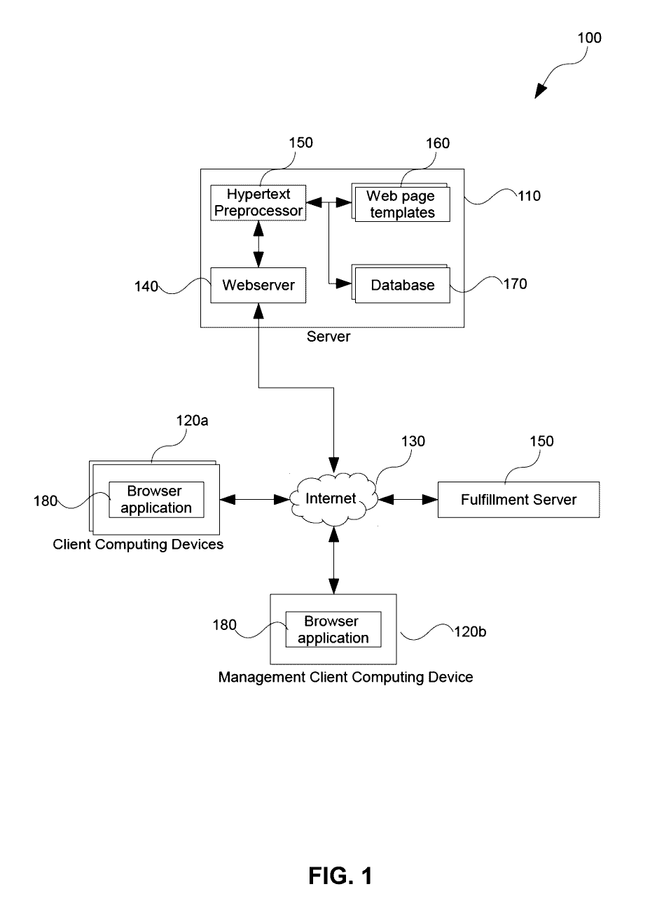

FIG. 1 shows a system 100 of computing devices adapted for price-adjusted item purchaser aggregation. As will be described in further detail below, the system 100, in general terms, allows purchasers to purchase items such as goods and services at adjusted rates by aggregating purchasers. The system is typically adapted so that users are able to initiate a search either for a specific item that they are interested in purchasing, or they may search instead for a preferred seller, e.g. ‘Widgets are us’. In this manner, the user may see if the item they are interested in has previously been offered at a discounted rate to other users, or if their preferred seller has any current offers for discounted deals. The user may also see whether their preferred seller has previously made an offer to other users of a discounted rate whereby the user may request that they be offered the same or a similar discounted rate for purchases from the particular seller.

Specifically, and as will also be described in further detail below, a purchaser may wish to purchase an item, such as a television, at a price that is below the recommended retail price for that item. In this manner, using the system 100, the purchaser is able to request an adjusted purchase price for the television. So too, can other prospective purchasers elect the same or other adjusted purchase price requests for the television. In embodiments, the adjusted price request data is transmitted to other users across a social network so as to encourage other users of the social network to also request the adjusted purchase price. Having received a number of adjusted purchase price requests, the supplier of the goods or services may elect to accept the adjusted purchase price, allowing for the purchase of the goods or service at the request of an adjusted purchase price.

As such, the system 100 comprises a server 110 for serving web pages to one or more client computing devices 120 over the Internet 130.

In a preferred embodiment, the server 110 is a web server having a web server application 140 for receiving requests, such as Hypertext Transfer Protocol (HTTP) and File Transfer Protocol (FTP) requests, and serving hypertext web pages or files in response. The web server application 140 may be, for example the Apache™ or the Microsoft™ IIS HTTP server.

The server 110 is also provided with a hypertext preprocessor 150 for processing one or more web page templates 160 and data from one or more databases 170 to generate hypertext web pages. The hypertext preprocessor may, for example, be the PHP: Hypertext Preprocessor (PHP) or Microsoft Asp™ hypertext preprocessor. The web server 110 is also provided with web page templates 160, such as one or more PHP or ASP files.

Upon receiving a request from the web server application 140, the hypertext preprocessor 150 is operable to retrieve a web page template, from the web page templates 160, execute any dynamic content therein, including updating or loading information from the one or more databases 170, to compose a hypertext web page. The composed hypertext web page may comprise client side code, such as Javascript, for Document Object Model (DOM) manipulating, asynchronous HTTP requests and the like.

The database 170 is adapted for storing digital data including the below mentioned item identification data, discounted and price-adjusted request data, discounted item and price-adjusted item price offer data and the like.

Client computing devices 120 are provided with a browser application 180, such as the Mozilla Firefox™ or Microsoft Internet Explorer™ browser applications. The browser application 180 requests hypertext web pages from the web server 110 and renders the hypertext web pages on a display device 1020.

It should be noted that the web server architecture as provided herein is an exemplary embodiment. However, the system 100 need not necessarily be implemented in such a manner and may take the form of differing technical embodiments within the purposive scope of the embodiments described herein.

The system 100 is adapted such that, the server 110 is adapted for receiving, via the data network 130, item identification data representing an item, such as a Samsung television. The item identification data further comprises at least item price data representing a price for the item, such as $980 for the Samsung television.

The item identification data is usually input by the provider of the item such as the vendor of the Samsung televisions. In this manner, the database 170 of the server 110 may be populated with various items available for purchase at an adjusted price or discount.

Having received the item identification data, the server 110 is adapted for transmitting, via the data network 130 the item identification data to the plurality of client computing devices 120. In this manner, the users of the client computing devices 120 may view the various items available for purchase at an adjusted price or discount. For example, a user of a client computing device 120 may be able to see that the Samsung television is available at $980. As will be described in further detail below, in particular arrangements, the user of the client computing device 120 is able to search for various items by inputting various data into the client computing device 120 such as by way of text input, image input for image recognition and the like.

Also, in particular arrangements, the client computing device 120 takes the form of a mobile computing device such as an Apple iPhone, a smartphone running the Android operating system, an Apple iPad, android tablet device, or alternative mobile device or the like and runs a client side application for receiving user inputs such as price request inputs and other selections. The application would also obtain GPS or other location data and send it to the server so the server knows the location of the client computing device 120. However, the client computing device 120 need not necessarily be limited to this embodiment and the client computing device 120 may take the form of other computing devices, such as personal desktop computing devices with website browsers installed and the like. The client computing device 120 could also be a notebook, tablet or wearable computing device such as a watch or glasses.

Now, having viewed the item and the item price for the item using the client computing device 120, the user of the client computing device 120, may input, via a preferred user interface (e.g. custom user interface, a text input module or voice recognition module) of the client computing device 120, adjusted price request data representing an adjusted price request for the item. For example, the user of the client computing device 128 may request rather to pay $800 for the Samsung television instead of the advertised price of $980.

In a similar fashion, other users of other client computing devices 120 may also input adjusted price requests for the same item. In the example above, these other adjusted price request items may be other amounts, such as for example $780, $600, $920 and the like. However, in one embodiment, the adjusted price request for the item from the first user is syndicated across social networks and the like such that other users may simply elect for the same price-adjusted request. For example, the price-adjusted request for the Samsung television may be syndicated to friends of the user on a social network such that the social feed of the friends of the user could represent “Paul wants a Samsung television for $800, being a discount of $120”. In this manner, the friend may simply elect to like, ignore or otherwise similarly request the discount.

As such, the server 110 is adapted for receiving, via the data network 120 price-adjusted request data representing a plurality of price-adjusted requests from the various users of the respective plurality of client computing devices 120.

Having received the number of adjusted price requests, the service provider may elect to accept the request to purchase the item at the requested adjusted price, especially given the large number of prospective purchasers. As such, having accepted the price-adjusted request, the server 110 is adapted for transmitting; via the data network 130 price-adjusted item offer data representing a price-adjusted offer for purchase of the item. For example, the Samsung television vendor may accept the adjusted price for the Samsung television of $800 such that those users who had requested the adjusted rate of $800 or more would be able to purchase the Samsung television at the $800 purchase price.

The system 100 may further comprise a fulfillment server 150 which may be instructed or which may instruct suppliers/sellers to dispatch various products and services at the adjusted purchase price, as will be described in further detail below. Typically, the fulfillment server 150 would be operated by a particular goods and services provider, exposing functionality by way of an API or the like.

### Computing Device

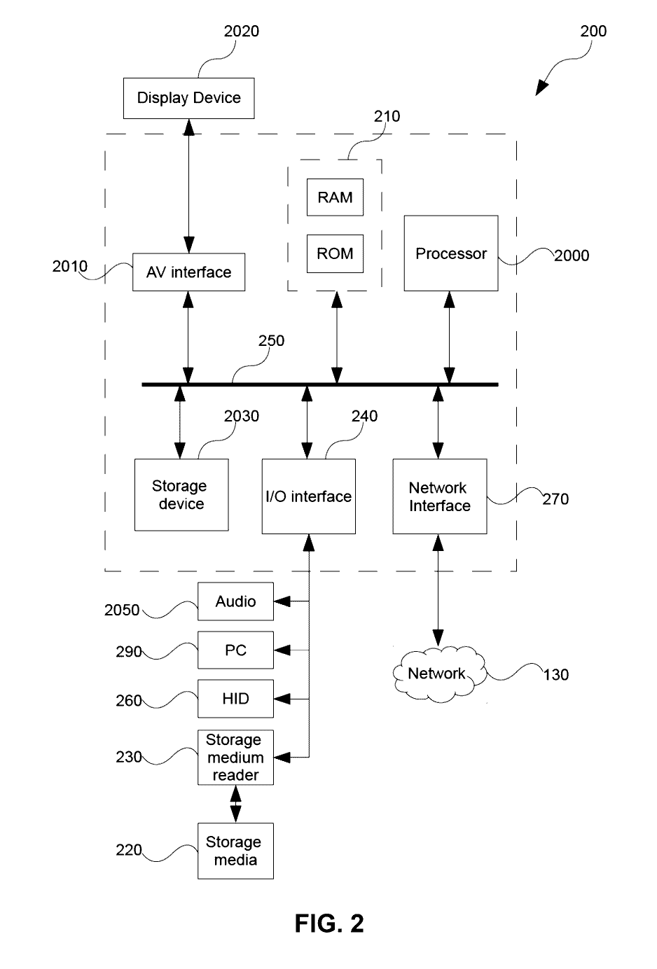

FIG. 2 shows a computing device 200. In a preferred embodiment, the computing device 200 takes the form of the server 110 as described above. In this manner, the computing device 200 is adapted to comprise functionality for communication with the Internet 130, storage capability (such as the database 170) for storing user account data and the like.

However, it should be noted that the computing device 200 may be adapted for use also as the client computing devices 120 is also shown in FIG. 1. In this manner, the computing device 200 may comprise differing technical integers, such as the display device 2020, human interface 260 and the like. In other words, the technical integers of the computing device 200 is shown in FIG. 2 are exemplary only and variations, adaptations and the like may be made thereto within the purposive scope of the embodiments described herein and having regard for the particular application of the computing device 200.

In particular, the steps of the method for discounted or price-adjusted item purchase aggregation, as described in further detail below, may be implemented as computer program code instructions executable by the computing device 200. The computer program code instructions may be divided into one or more computer program code instruction libraries, such as dynamic link libraries (DLL), wherein each of the libraries performs a one or more steps of the method. Additionally, a subset of the one or more of the libraries may perform graphical user interface tasks relating to the steps of the method.

The device 200 comprises semiconductor memory 210 comprising volatile memory such as random access memory (RAM) or read only memory (ROM). The memory 200 may comprise either RAM or ROM or a combination of RAM and ROM.

The device 200 comprises a computer program code storage medium reader 230 for reading the computer program code instructions from computer program code storage media 220. The storage media 220 may be optical media such as CD-ROM disks, magnetic media such as floppy disks and tape cassettes or flash media such as USB memory sticks.

The device further comprises I/O interface 240 for communicating with one or more peripheral devices. The I/O interface 240 may offer both serial and parallel interface connectivity. For example, the I/O interface 240 may comprise a Small Computer System Interface (SCSI), Universal Serial Bus (USB) or similar I/O interface for interfacing with the storage medium reader 230. The I/O interface 240 may also communicate with one or more human input devices (HID) 260 such as keyboards, pointing devices, joysticks and the like. The I/O interface 240 may also comprise a computer to computer interface, such as a Recommended Standard 232 (RS-232) interface, for interfacing the device 200 with one or more personal computer (PC) devices 290. The I/O interface 240 may also comprise an audio interface for communicate audio signals to one or more audio devices 2050, such as a speaker or a buzzer.

The device 200 also comprises a network interface 270 for communicating with one or more computer networks 280. The network 280 may be a wired network, such as a wired Ethernet™ network or a wireless network, such as a Bluetooth™ network or IEEE 802.11 network. The network 280 may be a local area network (LAN), such as a home or office computer network, or a wide area network (WAN), such as the Internet or private WAN.

The device 200 comprises an arithmetic logic unit or processor 2000 for performing or executing the computer program code instructions. The processor 2000 may be a reduced instruction set computer (RISC) or complex instruction set computer (CISC) processor or the like. The device 200 further comprises a storage device 2030, such as a magnetic disk hard drive or a solid state disk drive.

Computer program code instructions may be loaded into the storage device 2030 from the storage media 220 using the storage medium reader 230 or from the network 280 using network interface 270. During the bootstrap phase, an operating system and one or more software applications are loaded from the storage device 2030 into the memory 210. During the fetch-decode-execute cycle, the processor 2000 fetches computer program code instructions from memory 210, decodes the instructions into machine code, executes the instructions and stores one or more intermediate results in memory 200.

In this manner, the instructions stored in the memory 210, when retrieved and executed by the processor 2000, may configure the computing device 200 as a special-purpose machine that may perform the functions described herein.

The device 200 also comprises a video interface 2010 for conveying video signals to a display device 2020, such as a liquid crystal display (LCD), cathode-ray tube (CRT) or similar display device.

The device 200 also comprises a communication bus subsystem 250 for interconnecting the various devices described above. The bus subsystem 250 may offer parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like.

### Price-Adjusted Item Purchase Aggregation

Now, having described the technical architecture above, various exemplary user case embodiments will be described. It should be noted that these user case embodiments are exemplary only and that no technical limitation should necessarily be imputed to the claimed invention accordingly.

In these exemplary user embodiments, the user, or prospective purchaser, utilises a mobile communication device, such as an Apple iPhone, Android Phone, Samsung Phone, Apple iPad, Android tablet or the like (referred to in FIG. 1 as the client computing device 120). In order to avail the user of the functionality described herein, the user may download an executable software application to the client computing device 120 such as from the Apple iTunes™ Store or the like.

Alternatively, and is described in FIG. 1, the user may interact with a browser application 180 being executed by the client computing device 120.

Furthermore, in these exemplary arrangements, the client computing devices 120 communicates with the server 110 for performing the functionality described herein.

As alluded to above, and a general terms, the system 100 is adapted for aggregating prospective purchasers wishing to either receive a discount or purchase an item at an adjusted price. In this manner, the provider of the item may elect to provide the item at the requested discount or adjusted price.

### Item Browsing

As such, the exemplary user case embodiment starts with a prospective purchaser browsing for an item. In a first embodiment, the user is able to browse for perspective items for which to request adjusted pricing.

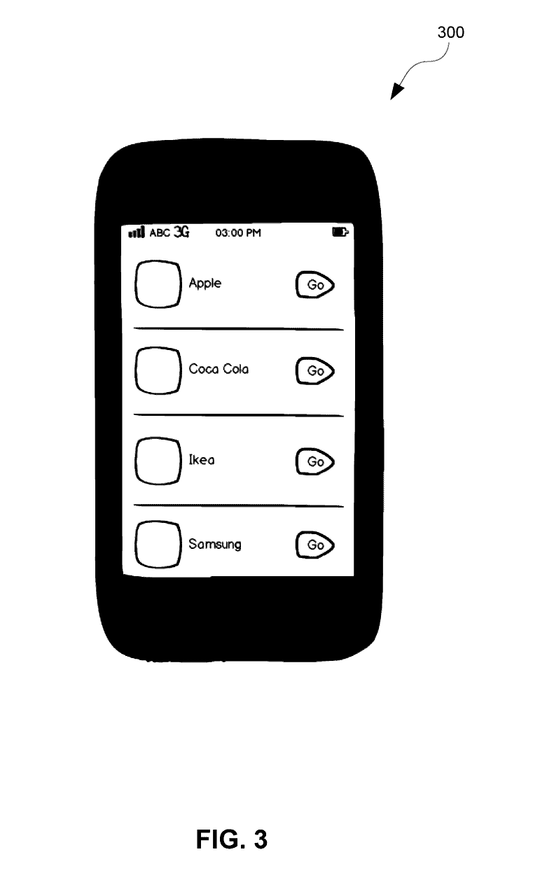

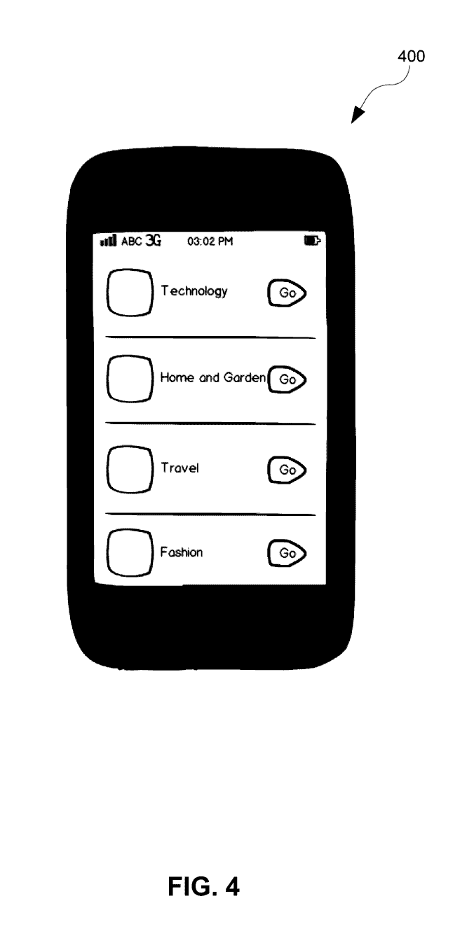

Specifically, referring to FIGS. 3 and 4, there is shown an exemplary graphical user interface adapted for display by the display device 1020 of the client computing device 120 allowing the user to browse for specific items.

In this arrangement, the server is adapted to send to the client computing device 120 catalogue data representing a catalogue of items or retail outlets, which, as will be described in further detail below, may be catalogued according to brand categories, goods and services categories and the like.

Specifically, referring to FIG. 3, the exemplary interface 300 comprises different brand categories allowing the user to select from differing brands from which to choose items. For example, should the user wish to purchase a Samsung television, the user may select the Samsung brand categories so as to be presented with the items sold by Samsung including the Samsung television.

Referring now to the exemplary graphical user interface 400 provided in FIG. 4, in this embodiment the user is able to browse for items by goods and services classification. Specifically, the exemplary interface provides the exemplary goods and services classifications of technology, vehicles, home and garden, travel, fashion and the like.

In other arrangements, the items may be catalogued according to other categories depending on the application.

In one arrangement the catalogue data is the same for all users of the system 100. However, in a preferred embodiment, the system 100 attempts to provide items to the user, which are of relevance to the user.

In this manner, the server 110 is adapted to send, to the client computing device 120, catalogue data which is specific to a user of the client computing device. In one embodiment, the catalogue data is specific to the location of the user of the client computing device 120. In this embodiment, prior to sending, to the client computing device 120 the catalogue data, the server 110 is adapted to receive, via the data network 130, from the client computing device 120, location data representing a location of the client computing device 120. In the embodiment where the client computing device 120 takes the form of a mobile communication device, the mobile communication device may have an inbuilt GPS adapted for determining location of the client computing device 120. In other embodiments the location of the client computing device may be ascertained by other mechanism such as cellular triangulation, user specification and the like.

In this manner, the system 100 is advantageously able to provide to the user local retail outlets or goods and services, which may be more relevant to the user.

In another arrangement, the server 110 is adapted to select the catalogue data in accordance with the social friends of the user so as to provide items to the user which are of interest to the user's friends/acquaintances/associates.

In this arrangement, when registering with the server 110, the user may be required to input their social network credentials representing the authentication credentials for a social network, for example, the user may log-in to the server using the log-in credentials of a preferred social media platform such as Facebook. Thereafter, when selecting the catalogue data, the server 110 may be adapted to authenticate with the nominated social network, and traverse the social graph of the user so as to ascertain the social friends of the user. In this manner, should a friend/acquaintance/associate of a social user, using the system 100, show interest in a particular item, such as a Samsung television, such as by requesting a adjusted price for the television, “liking” the Samsung television or the like, the server 110 may be adapted to similarly offer the Samsung television to the user by way of the catalogue data. This offer may already include an adjusted price considering the price-adjusted request and/or retailer offer and/or user purchase history of the particular item being offered. That is, using the example above, the price offered to the friend ($800) may be the same as that previously offered to the initial user or users who received price-adjusted offers for that item.

In other arrangements, the catalogue data may be configured by the server 110 in other manners so as to be more relevant to the user. Such other embodiments include ascertaining user preferences in accordance with historical user interaction data wherein, for example, should the user have shown a prior interest in televisions, the server 110 would bias the items of the catalogue data towards televisions and other related items.

### Item Specification

In a further embodiment, as opposed to the user browsing for a particular item, the user may specify an item of interest. In other words, the server 110 is further adapted to receive, via the data network 130, user generated item identification data representing the item. In this manner, the user may specify any items of interest, including those not currently within the database 170 of the server 110.

In a first arrangement, the user generated item identification data comprises at least one keyword. For example, the user may input, into the client computing device 120, keywords such as one or more of “Samsung”, “television”, “42 inch”, “LED” and the like so as to identify the item in which they are interested in.

Upon receipt of such keywords, the server 110, is adapted to search within the database 170 for an item matching the keyword request. In the arrangement where the particular item identification data is already recorded within the database 170, the server 110 need only retrieve the item identification data from the database 170 and present it to the user via the client computing device.

However, in arrangements where the user proposes a new item, the item identification data may not be contained within the database 170. In this arrangement, the server 110 may be adapted to retrieve the item identification data from third party sources, such as from product and services APIs and the like.

For example, the server 110 may be adapted to request, across a data network 130, from a server implementing an API relating to Samsung products, information relating to Samsung products matching the keywords. Upon receipt of such item identification data from the third party server, the server 110 may update the database 170 with the information for future reference.

In another arrangement, the user may use an image capture device (e.g. camera) of the mobile communication device 120 for the purposes of capturing image data of the selected item.

For example, when browsing through a print catalogue, the user may come across the Samsung television advertised for $980. Not wishing to pay the full amount for the Samsung television, the user may capture an image of the advertised television from the catalogue using their client computing device 120. In this manner, either the client computing device 120, or the server 110, upon receipt of the image data from the client computing device 120, may be adapted to perform text recognition technique so as to identify various text within the advertisement and, such as the name and price of the item, the product identification number or the like so as to be able to uniquely identify the product. In embodiments where more than one product match the text in the image recognised by the text recognition technique, the system 100 may present a plurality of potential matches to the user for selection.

In other arrangements, as opposed to using a text recognition technique, the client computing device 120, or the server 110, may be adapted to perform image recognition techniques. In this manner, the database 170, or the third party server as the case may be, may comprise image data relating to various items. In this manner, upon receipt of the image data of the Samsung television, the server 110 may be adapted to select from the image data within the database 170, the closest image match to the image data taken by the user. Various image matching techniques may be employed by the server, such as contour matching, colour matching, trademark recognition and the like.

### Product Addition

In one embodiment, so as to increase the number of goods and services within the database 170, the system 100 may be configured to allow or indeed incentivise users to add data relating to various products and services, for inclusion into the database.

For example, the software application executable by the client computing device 120 may have a “product adder” or functionality allowing users to add goods and services, such as by way of scanning product barcodes, taking photographs, adding other informational the like. In one embodiment, users who have added products and services may be incentivised for the subsequent sales of the products and services, such as by receiving a commission or the like.

Yet further, in certain embodiments, the system 100 may be configured to allow product and service rating by users of the system 100 wherein products may be up-voted and down-voted to depending on popularity.

Similarly, in one embodiment, so as to increase the number of retail stores eligible to offer discounts within the system 100, the system 100 may be configured to allow users to request a retail outlet be added to the database.

### Adjusted Price Request (Wish List)

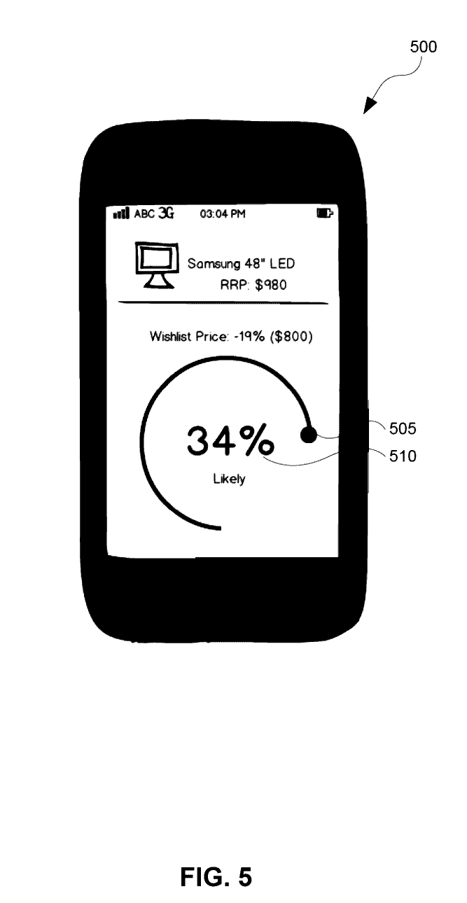

Referring to FIG. 5, there is shown an exemplary graphical user interface 500 allowing the user of the client computing device 120 to specify the adjusted or desired price request. The discounted or adjusted price request may be referred to as a “wish list” item.

The interface 505 comprises details of the selected item (eg, using the above example, the Samsung 48 inch LED television having a recommended retail price of $980).

The exemplary interface 500 comprises a slider 505 operable to specify the discounted or adjusted price request. In the arrangement shown, the slider is a circular slider 505.

The slider 505 may be configured with two value ranges, comprising a first value range representing the full amount for the item, and a second value range representing a percentage discount off the item, such as a maximum of 80%, for example. In this manner, using the slider 505, the user may specify an adjusted price request anywhere from 0 to 80%.

In the exemplary interface, the user has utilised slider 505 to request a discounted or adjusted price request (referred to as a wish list price in the interface 500) of $800, or a discount of 19% off the recommended retail price.

Now, in a particular arrangement, the system 100 is adapted to calculate a probability of acceptance of the adjusted price request by the retailer or supplier. The greater the discount requested by the user, the less likely the probability of the discounted or price-adjusted item price being offered by the supplier.

As such, referring to the exemplary interface 500, there is shown the interface 500 comprising an acceptance probability 510, currently shown as 34% likely in the example. In other words, at the nominated discounted or adjusted price request of a 19% discount, the system 100 calculates that the user has a 34% probability of having the adjusted price request met by the supplier.

In one arrangement, where the adjusted price request is made by moving a slider element on a user interface, the module controlling the slider can be programmed to make part of a slider graphic change colour to indicate the likelihood of the offer being accepted.

There are a number of manners by which the adjusted price may be calculated by the system 100. In one embodiment, the price-adjusted request data is calculated in accordance with historical price-adjusted item price offered data. For example, should a supplier routinely accept adjusted price requests at about 19%, the system 100 could allocate a high probability as opposed to should the supplier routinely not accept adjusted price request that about 19%.

In a further embodiment, the adjusted price acceptance probability data is calculated in accordance with the number of the price-adjusted requests. For example, should 200 users request the adjusted price, the system 100 would allocate a higher probably of acceptance by the supplier as opposed to should only 5 users request the adjusted price.

In a particular arrangement, the user may be required to commit to purchase the item at the nominated adjusted price should the nominated item subsequently be offered at that adjusted price. In such arrangement, the user may be required to input credit card details and the like which may be subsequently billed in an automated fashion upon the offering of the item at the adjusted price requested.

In other embodiments, the user may simply wish to receive notification of the price-adjusted item price. For example, in the exemplary arrangement where the user has selected a nominated discount of less 19%, the user would receive notification of any discount of the Samsung television for 19% or greater.

In a yet further arrangement, upon acceptance of an offer for an item at an adjusted price (as will be described in further detail below) the system 100 may be adapted to implement the escrow of the price-adjusted item offer. In this manner, once having made the price-adjusted item offer, the supplier would receive notification that the price-adjusted item price funds have been received from the customer and now been held in escrow by the system 100. Thereafter the supplier is able to dispatch the goods whereafter, upon verification of successful delivery of the item by the customer, the funds would be released to the supplier.

### Related Goods and Services

In one embodiment, so as to broaden the scope of potential items, the user may elect to receive notifications of price-adjusted item prices for related goods and services.

For example, should the user have expressed an interest in receiving notifications of a discount off a Samsung television, the user may similarly receive notifications of the discount of other Samsung items, such as the Samsung Galaxy Tab computing device.

However, the related goods and services need not necessarily be provided by the same service provider in that the user may equally receive a notification relating to the price-adjusted item price of, for example, an Apple iPad.

There are a number of ways by which the server 110 is able to calculate related goods and services. In the first manner, and as alluded to above, the server 110 relates goods and services by the supplier, such as, for example, Samsung or Apple. In another manner, the server 110 is able to relate goods and services by category, such as technology, home and garden and other categories.

In a yet further manner, the server 110 is able to relate goods and services in accordance with user interaction data wherein user preferences for similar goods and services are utilised for the purposes of recommended similar goods and services to other users.

### Adjusted Dollar Amount

In the embodiments are described herein, the user is able to specify a discount or amount for products and services. However, in other arrangements, the user may equally nominate a maximum dollar amount that the user would pay for an item.

For example, as opposed to specifying that the user would wish for greater than 19% discount off the recommended retail price of the Samsung television, the user could nominate that the maximum amount that the user would pay for the Samsung television is $800.

### Demand Statistics

When requesting discounted or adjusted prices in the manner described above, the interface 500 may be adapted to display information relating to demand for a particular product or service.

For example, the interface 500 may display the number of other users who have requested discounted or adjusted prices for a nominated item. The demand statistics may further be broken down in accordance with location such as overlaid a map. The demand statistics may also comprise statistics relating to the discount amount such as the maximum, minimum and average discount amount requested for a product or service. For example, the interface 500 may display to the user the average price for the item being requested by other users and, using such information, may make a similar request for an adjusted price on the item in question e.g. the user may request an adjusted price in line with the average price being requested by other users of the system. The other users requests that are seen by the user may be restricted to those users who are also friends/acquaintances/associates of the user on the users preferred social media platform, however, in other arrangements, the other users may simply be members of the general public having no prior relationship with the user. In further arrangements, the user may also be provided, via the interface 500, with information relating to the number of offers that have been made by retailers/suppliers for a particular item or similar items. In this way, the user may request a price-adjustment of the item based on the previous offers made by the supplier to increase the chances of the requested price being offered. For example, using the above example of the Samsung television, the user may see that the retailer has previously made offers to purchase the item at $850. Accordingly, the user may realize that requesting a price of $800 may have only a low probability of being accepted and therefore may request a price closer to that of the previous offers made by the retailer/supplier.

### Price Requests Syndication

Now, having received the discounted or adjusted price request data from the user such as where, using the example above, the user wishes to purchase the Samsung television for $800 as opposed to $980, the system 100, so as to advantageously increase the number of other uses similarly requesting the same discount or price so as to increase the probability of the provider accepting the discount request in accordance with a number of request is, is adapted to syndicate, via the data network 130, the discounted or adjusted price request data.

In a first embodiment, the system 100 is adapted to syndicate the discount price request using a social network. As alluded to above, when registering with the server 110, the user may be required to input into the client computing device 120, social network authentication credentials. In this manner, upon receipt of the discounted or adjusted price request data from the user, the server 110 may be adapted to authenticate with the nominated social network using the social network authentication credentials so as to syndicate the discounted or adjusted price request data to the friends or other uses of the social network. The system 100 or the server 110 may be adapted to optionally keep price requests private so the system 100 or server 110 gives users the option to share their price requests or keep them private, for example, from their network.

In practice, the social network data feed of the friends of the user may display something along the lines of “Paul wants the Samsung television for $800 as opposed to $920”. In this manner, Paul's friends, similarly wishing for the Samsung television at the discounted or adjusted price may “like” or otherwise use a provided hyperlink or the like to similarly join in the request.

For example, the data of the notification may comprise a hyperlink to a web resource served by the server 110, the hyperlink comprising a unique identifier of the discounted or adjusted price request by the user. In this manner, by clicking on the hyperlink, the friend would be redirected to a webpage served by the server 110 displaying the discounted or adjusted price request data (and potentially allowing the friend to vary the discounted or adjusted price request), the particular item and the like. The friend may be requested by the resource to authenticate with the server 110 so as to confirm the further discounted or adjusted price request.

In other arrangements, the discounted or adjusted price request may be syndicated in other manners. In one manner, the user may provide a list of email addresses to which emails or sent by the server 110 comprising information relating to the discounted or adjusted price request.

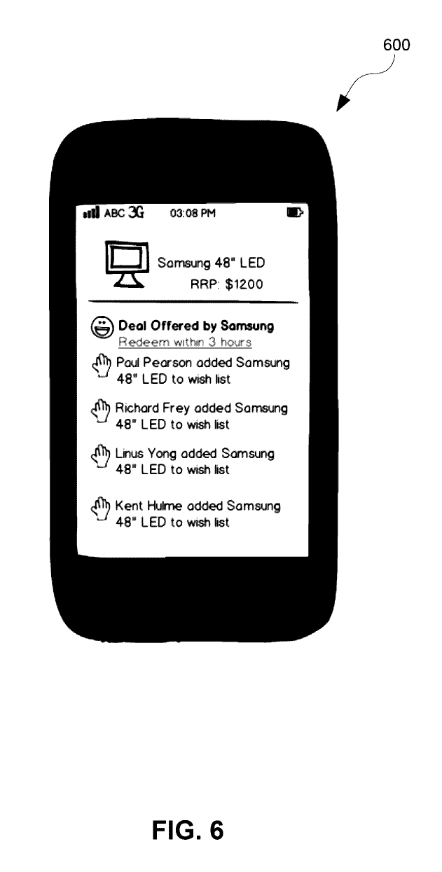

Referring to the exemplary graphical user interface 600 as substantially provided in FIG. 6, there is shown an activity feed representing the activity by other uses in relation to the item. Specifically, the interface 600 shows the Samsung television item. The activity feed, in reverse chronological order shows that user Kent Hulme added the Samsung television to his wish list and then Linus, Richard and Paul also subsequently added the television to their wish list for $800. The final entry of the activity feed indicates that the deal has been offered by Samsung.

As is evident from the interface 600, the final activity feed entry related to the offering of the deal, which comprises means by which to accept the offer, provided as a hyperlink in the interface 600. In certain embodiments, uses may be given a predetermined window in which to accept the offer. In the example interface 600, users have three hours in which to accept the offer.

### Wish List Browsing

In a further arrangement, in addition or alternative to the above described adjusted price requests syndication, the system 100 may be adapted to allow users to view wish list items of other users of the system 100.

For example, uses related to other users on a social network may be able to view those items which those other uses have added to their wish lists.

Uses may configure their privacy settings so as to allow for the publicity of their wish list items or not.

### Item Redemption—Barcodes

Now, having been offered the discount or price-adjusted item price by the service provider, there will now be described example arrangements wherein the user is able to redeem the discount or price-adjusted item price offered.

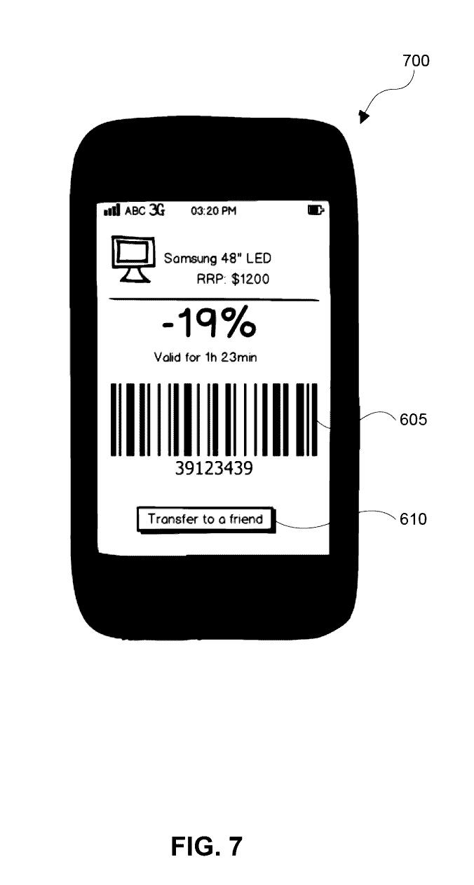

Specifically, referring to FIG. 7, there is shown an exemplary embodiment where a user is able to redeem the discount or price-adjusted item price by way of a barcode. Specifically, the interface 700 comprises the barcode representation 605 uniquely identifying the discounted or price-adjusted item price offer of less 19%.

In this manner, at the point of sale terminal at the electronic goods outlet, the user may proffer their phone to have the barcode 605 scanned to reduce the retail price of the Samsung television.

As is also evident, the barcode 605 comprises a unique numeric number which may alternatively be used for online redemption or other application where barcode scanner is not feasible.

In one embodiment, the discounted or price-adjusted item price offer is transferable between users. In this manner, should the user, having received the discounted or price-adjusted item price offer, not wish to, or not be able to redeem the discounted or price-adjusted item price offer, the user may transfer the price-adjusted item price offered to another user.

The transfer of the discounted or price-adjusted item price offer may be affected in a number of ways, such as by inputting identification details of the recipient user. Alternatively, the discounted or price-adjusted item price offer data may be transmitted to the recipient user by way of email, SMS, MMS and the like.

It should be noted that while a 1-D barcode is shown in the interface 700, in other embodiments, other types of discounted or price-adjusted item price identification data may be employed, such as 2-D barcodes and the like.

### Item Redemption—Geo-Radius Redemption

In another embodiment, as opposed to utilising barcodes as described above for the purposes of redeeming discounted or adjusted price offerings, the system 100 may be adapted for utilisation of geo-radius redemption of discounted or adjusted price offerings.

For example, when wishing to redeem an adjusted price offering, the user may travel to the store to collect the nominated item, the Samsung television in this example. At the store, the user may utilise the software application of their client computing device 120 to initiate the redemption process. In this manner, the client computing device 120 would send location data representing a location of the client computing device to the server 110.

The server 110 would calculate that the location of the client computing device 120 and the store are within radius so as to allow for the offering of the item.

### Item Price Offering (Pushing Deals)

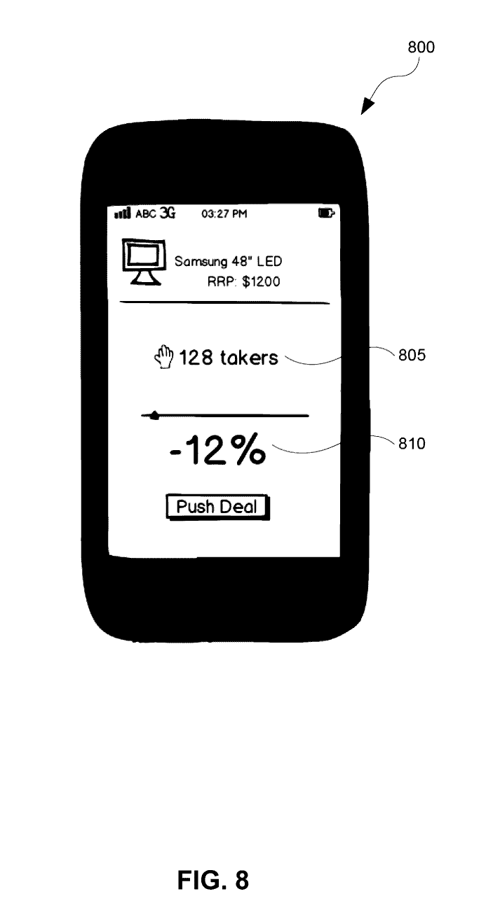

Referring to FIG. 8, there is shown an exemplary graphical user interface 800 displayed by the management client computing device 120b. As will now be described, the management client computing device 120 is used by product suppliers and the like in determining the adjusted priced item price offering to make.

In the exemplary interface 800, the interface 800 displays the specific Samsung television for which the supplier is considering offering.

Then, using discount slider 810, the supplier is able to vary the discount amount, typically along the above-mentioned ranges of 0 to 80%. As the value of the discount slider 810 is manipulated, the number of takers 805 varies.

In the example, at the proposed adjusted priced item price of less 12%, the interface 800 represents that the supplier would have 128 customers willing to purchase the Samsung television.

As such, by using the interface 800, the supplier can make a decision as to the appropriate item price to offer so as to attract the requisite number of takers.

Having selected the desired item price, the supplier is able to use the interface 800 to “push” the deal at the selected item price.

In this manner, all of those recipients who were willing to pay greater than $800 for the Samsung television, would receive notification that the supplier had pushed the deal.

It should be noted that while in the manner described above, the adjusted amount pushed to users is performed in a manual fashion. However, in other manners, suppliers, retailers and the like may configure the system 100 such that the item price is offered in an automated manner, such as when the number of requests exceed a certain threshold determined in accordance with the price amount.

In certain arrangements, the deal may be pushed only to certain users, such as the probability of the user converting into a customer with probability may be determined by the location of the customer, the deal expiry time, previous customer conversion rates and the like.

When pushing deals, the system 100 may be configured to integrate shopping so as to, for example, configure pricing to take into account, product sizes and weights, delivery destinations and the like.

The sellers may pay a fee for providing offers to the users of the system. In particular arrangements, this fee may be calculated as an advertisement cost per offer and may be determined as a function of one or more factors, where such factors may be chosen from one or more of the availability timeframe for the offered deal, historic offer conversion rates, consumer/user demand, and/or as a function of the number of users receiving the particular offer. It is envisaged that the systems described herein would provide benefits to the sellers advertising on the system to users of the system, such advantages including provisional of low cost/high conversion rate marketing services and identification of an optimal price point for specific items based on direct user demand.

### Geo-Targeted Discount and Price Offering

In a particular arrangement, suppliers may be able to specify geographic locations within which to offer the discounted or price-adjusted item price.

For example, a television retailer may configure the system 100 such that prospective customers who have elected to receive notifications of the discounting of a Samsung television of greater than 19%, would receive a notification when being in proximity of the retail outlet.

It will be apparent how the system 100 captures customer buying impulse, location (if and when possible) and price point sensitivity in real time. The system also allows sellers to view this demand and price sensitivity in real time and respond with qualified offers to these clients.

### Further Examples

Additional examples of usage of any one or any combination of two or more of the arrangements discussed above include:

The user may be able to set a minimum deal value (in percentage) to be notified about from a business. For instance, users, may search a list of businesses associated with the system and add them to a wish list, where the wish list is a list of deals the users wishes to be notified about and/or a list of businesses from which the user wishes to receive notification of a discount offer for items offered by those businesses for sale. The user may choose to set a percentage value using a circular slider that indicates the minimum deal that they want to be notified about. The user may also opt-in to be notified about deals from similar businesses to those on their wish list, for example, a particular user likes to shop and ‘Widgets R Us’. The user sets an acceptable deal that would entice them to shop at ‘Widgets R Us’ e.g. the user wants 10% off at ‘Widgets R us’ and wants a notification at any time if this is possible. The user also may opt-in to hearing about the same deal at stores similar to ‘Widgets R us’.

In a further example a user, may set a maximum deal value (dollar amount) to be notified about i.e. on a specific product. The user may be able to search a list of products and add them to their wishlist or otherwise indicate that they are interested in a specific product. The user may set a dollar value using a circular slider that indicates the maximum price they want to pay for a specific product. Furthermore, the user may also, opt-in to be notified about deals on similar products and/or offered by specific businesses.

In a further example, the user may be able to view metrics and a likelihood indicator to assist in setting a deal and also to view statistics on past deals to assist in setting a realistic discount value. The user may also be able to view an indicator of how likely it is that they will receive a requested deal based on past deals.

In a further example, the user may be notified of a deal offered to them from a business or on a product, based on preselected criteria, for example, the system may use geo location to target such notifications in the user's context. For instance, say the user is at a shopping centre, and is just about to walk past a store on their wish list. In this instance, the user may receive a deal from the store they are approaching.

In a further example, the use may use a unique barcode on a mobile device e.g. a smartphone, to redeem a percentage discount at a business. In this scenario, the business scans a barcode displayed on the mobile device at the point of sale. The scanned barcode is used to match the user to an offered deal which is then applied at the point of sale.

In a further example, the system may utilize geo-location to track conversion from deal to redemption in-store. For instance, when a barcode is displayed and the geographic location of the user at the time the barcode is displayed is in a predefined radius of the business offering a deal associated with that particular displayed barcode, then a conversion of the deal is registered and stored for subsequent statistical analysis.

In a further example, a user may forward a deal they have been offered have received on to one or more friends or acquaintances on a friend list. For instance, if the deal offered is restricted to a particular time window for any reason, the user may be able to forward the deal to a friend so that the friend may take advantage of the deal. For example, the wife of a particular user is at the shops, whereas the user is still at work. A deal offer is received, but the deal expires in 30 minutes so the user will not be able to take advantage of it. The user may choose to forward the deal to their wife so that the deal is not missed.

In further arrangements, the user may be able to view wish lists constructed by friends, should those friends choose to make their wish lists public. In this scenario, the user would also have the option of marking a particular request as private where such marked deal requests are not viewable by friends or acquaintances of the user.

In further arrangements, the user may be able to view what friends of the user want. In this scenario, the user may be able to derive an inspiration on setting their deals, and may also be able to view where the users' friends like to shop.

In the above example, the user may also be allowed to restrict access to their requests and shopping information e.g. the user may elect to not allow their friends to view certain items in the user's wish list for whatever reason.

In further arrangements, the user may be able to view demand for deals on particular products and at particular businesses, and may be able to view details on the number of users interested in a particular business or product. The user may additionally be able to view geo-location summary information about those users; to view specific numbers at specific deal prices; and to view user conversion rates.

In further arrangements, the business operator (or their agent or employees) may push a deal to a user based on their geo location, the time of day and their likelihood of converting as a customer. The facility to push a deal to a user may be offered at a price per push determined by the system based on the user's chance of converting the offer into a sale. The chance of converting may be determined by the location of customer; the deal expiry time; and/or past customer conversion rates.

In further arrangements, the system may provide a Product Adder′, which may be utilized on the user's mobile device, e.g. smartphone, to add products and/or services to the system while on the go. The Product Adder functionality may be provided by scanning of the product's barcode with the mobile device, and/or taking a photograph of the item, and/or manually add some information about the item into the mobile device. A particular arrangement, to provide an incentive for users to add products to the system, the user may receive a commission based on sales of the products that they have added.

In further arrangements, the system may be adapted to receive specific requests from users for particular products to be added to the system or for particular stores/sellers to market their services through the system. Sellers may be notified of such requests, and, depending on demand amongst other factors as would be appreciated by the skilled addressee, such sellers may choose to take up the option of advertising their goods and/or services, though the system disclosed herein.

In further arrangements, the system may be adapted to interface with social media platforms, such as for example, Facebook or Twitter. In this manner, the system could be adapted to provide a collaborative, crowd sourced database of products identified by unique barcode with additional social media interaction features such as, crowd upvoting, downvoting to refine marketing messages and assign commissions.

In further arrangements, the system may provide integrated shipping services. Such services may be based on standardised prices with respect to the size and weight of product items. The delivery services may also provide, point of delivery conversion, and feedback of the product delivered to customer. On delivery, the customer verifies product and notifies the system of receipt of the goods. Funds are then transferred from escrow to the seller upon confirmation of receipt of the product.

### Interpretation

### Social Graph

The term ‘social graph’ as used herein is a data structure comprising one or more connections describing the relationships between individuals (and the relationships between individuals online in one embodiment) and is defined explicitly by the one or more connections.

### Bus

In the context of this document, the term “bus” and its derivatives, while being described in a preferred embodiment as being a communication bus subsystem for interconnecting various devices including by way of parallel connectivity such as Industry Standard Architecture (ISA), conventional Peripheral Component Interconnect (PCI) and the like or serial connectivity such as PCI Express (PCIe), Serial Advanced Technology Attachment (Serial ATA) and the like, should be construed broadly herein as any system for communicating data.

In Accordance with

As described herein, ‘in accordance with’ may also mean ‘as a function of’ and is not necessarily limited to the integers specified in relation thereto.

### Composite Items

As described herein, ‘a computer implemented method’ should not necessarily be inferred as being performed by a single processor or computing device such that the steps of the method may be performed by more than one cooperating computing devices.

Similarly objects as used herein such as ‘web server’, ‘server’, ‘client computing device’, ‘computer readable medium’ and the like should not necessarily be construed as being a single object, and may be implemented as a two or more objects in cooperation, such as, for example, a web server being construed as two or more web servers in a server farm cooperating to achieve a desired goal or a computer readable medium being distributed in a composite manner, such as program code being provided on a compact disk activatable by a license key downloadable from a computer network.

### Database

In the context of this document, the term “database” and its derivatives may be used to describe a single database, a set of databases, a system of databases or the like. The system of databases may comprise a set of databases wherein the set of databases may be stored on a single implementation or span across multiple implementations. The term “database” is also not limited to refer to a certain database format rather may refer to any database format. For example, database formats may include MySQL, MySQLi, XML or the like.

### Wireless

The invention may be embodied using devices conforming to other network standards and for other applications, including, for example other WLAN standards and other wireless standards. Applications that can be accommodated include IEEE 802.11 wireless LANs and links, and wireless Ethernet.

In the context of this document, the term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. In the context of this document, the term “wired” and its derivatives may be used to describe circuits, devices, systems, methods, techniques, communications channels, etc., that may communicate data through the use of modulated electromagnetic radiation through a solid medium. The term does not imply that the associated devices are coupled by electrically conductive wires.

### Processes

Unless specifically stated otherwise, as apparent from the following discussions, it is appreciated that throughout the specification discussions utilizing terms such as “processing”, “computing”, “calculating”, “determining”, “analysing” or the like, refer to the action and/or processes of a computer or computing system, or similar electronic computing device, that manipulate and/or transform data represented as physical, such as electronic, quantities into other data similarly represented as physical quantities.

### Processor

In a similar manner, the term “processor” may refer to any device or portion of a device that processes electronic data, e.g., from registers and/or memory to transform that electronic data into other electronic data that, e.g., may be stored in registers and/or memory. A “computer” or a “computing device” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. The processing system further may include a memory subsystem including main RAM and/or a static RAM, and/or ROM.

### Computer-Readable Medium

Furthermore, a computer-readable carrier medium may form, or be included in a computer program product. A computer program product can be stored on a computer usable carrier medium, the computer program product comprising a computer readable program means for causing a processor to perform a method as described herein.

### Networked or Multiple Processors

In alternative embodiments, the one or more processors operate as a standalone device or may be connected, e.g., networked to other processor(s), in a networked deployment, the one or more processors may operate in the capacity of a server or a client machine in server-client network environment, or as a peer machine in a peer-to-peer or distributed network environment. The one or more processors may form a web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

### Additional Embodiments

Thus, one embodiment of each of the methods described herein is in the form of a computer-readable carrier medium carrying a set of instructions, e.g., a computer program that are for execution on one or more processors. Thus, as will be appreciated by those skilled in the art, embodiments of the present invention may be embodied as a method, an apparatus such as a special purpose apparatus, an apparatus such as a data processing system, or a computer-readable carrier medium. The computer-readable carrier medium carries computer readable code including a set of instructions that when executed on one or more processors cause a processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

### Carrier Medium

The software may further be transmitted or received over a network via a network interface device. While the carrier medium is shown in an example embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media.

### Implementation

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Means for Carrying Out a Method or Function

Furthermore, some of the embodiments are described herein as a method or combination of elements of a method that can be implemented by a processor of a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

### Connected

Similarly, it is to be noticed that the term connected, when used in the claims, should not be interpreted as being limitative to direct connections only. Thus, the scope of the expression a device A connected to a device B should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

As used herein, the term “exemplary” is used in the sense of providing examples, as opposed to indicating quality. That is, an “exemplary embodiment” is an embodiment provided as an example, as opposed to necessarily being an embodiment of exemplary quality for example serving as a desirable model or representing the best of its kind.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### TERMINOLOGY

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

1. A system for adjusted priced item purchaser aggregation, the system comprising:
a data network adapted for transmitting digital data;
a server operably coupled to the data network; and
a plurality of client computing devices in operable communication with the server across the data network; wherein, in use:
the server is adapted for receiving, via the data network, item identification data representing an item, the item identification data comprising at least item price data representing a price for the item;
the server is adapted for transmitting, via the data network, to the plurality of client computing devices, the item identification data;
the server is adapted for receiving, via the data network, adjusted price request data representing a plurality of adjusted price requests for adjusted price amounts for the item or discounts applicable to retail outlets from the plurality of client computing devices; and
the server is adapted for transmitting, via the data network, to the plurality of client computing devices, adjusted priced item price offer data representing an adjusted offer price for the item.

2. The system as claimed in claim 1, wherein the server is further adapted for calculating the adjusted priced item price offer data in accordance with the adjusted price request data.

3. The system as claimed in claim 1, wherein a server is further adapted to receive, via the network interface, the adjusted priced item price offer data.

4. The system as claimed in claim 1, wherein the server is further adapted for transmitting, via the data network, to the plurality of client computing devices, catalogue data representing a catalogue of items, wherein the catalogue data comprises at least one of brand categories and goods and services and retail store classification catalogues, wherein the server is further adapted to select the catalogue data, in accordance with a user specific data associated with a client computing device, and wherein the user specific data comprises at least one of location data and social network data.

5-9. (canceled)

10. The system as claimed in claim 1, wherein the server is further adapted to receive, via the data network, user generated item identification data representing the item, the user generated item identification data comprising at least one of a keyword, image data, and social network interaction data; wherein the server is further adapted to identify the item in accordance with a text recognition technique or an image recognition technique; and wherein the server is further adapted to request, via the data network, the item identification data in accordance with the user generated item identification data.

11-16. (canceled)

17. The system as claimed in claim 1, wherein the server is further adapted to syndicate, via the data network, the adjusted price request data.

18. (canceled)

19. The system as claimed in claim 1, wherein each of the plurality of client computing devices is adapted to receive, via user interface, the adjusted price request data, wherein the user interface is adapted to display a control operable by a user for varying the adjusted price request, wherein each of the plurality of client computing devices is adapted to display, using a display device, adjusted price offer probability data representing a probability of the offer of the adjusted price request.

20-21. (canceled)

22. The system as claimed in claim 19, wherein the adjusted price offer probability data is calculated in accordance with at least one of the adjusted price request, historical adjusted priced item price offer data, and a number of the plurality of adjusted price requests.

23-24. (canceled)

25. The system as claimed in claim 1, wherein the adjusted priced item price data comprises identification data uniquely identifying the adjusted priced item price, the identification data adapted for use in redeeming the adjusted priced item price, wherein the identification data comprises scannable identification data, wherein the scannable identification data includes barcode data including 1-D and 2-D barcode data.

26-28. (canceled)

29. The system as claimed in claim 1, wherein the server is further adapted for receiving, via the data network, location data representing a location of a client computing device and offering a price in accordance with the discounted item price offer data.

30. The system as claimed in claim 1, wherein the adjusted price request data is lower price request data representing a plurality of lower price requests or a higher price request data representing a plurality of higher price requests.

31. (canceled)

32. A server for adjusted price item purchaser aggregation, the server comprising:
a processor for processing digital data;
a memory device for storing digital data including computer program code, the memory device being operably coupled to the processor; and
a network interface for transmitting data across a data network, the network interface being operably coupled to the processor wherein, in use, the processor is controlled by the computer program code to:
receive, via the data network, item identification data representing an item, the item identification data comprising at least item price data representing a price for the item;
transmit, via the data network, to a plurality of client computing devices, the item identification data;
receive, via the data network, adjusted price request data representing a plurality of adjusted price requests for adjusted price amounts for the item or discounts from retail stores from the plurality of client computing devices; and
transmit, via the data network, to the plurality of client computing devices, adjusted priced item price offer data representing an adjusted offer price for the item.

33. The server as claimed in claim 32, wherein the processor is further controlled by the computer program code to calculate the adjusted priced item price offer data in accordance with the adjusted price request data.

34. The server as claimed in claim 32, wherein the processor is further controlled by the computer program code to receive, via the network interface, the adjusted priced item price offer data.

35. The server as claimed in claim 32, wherein the processor is further controlled by the computer program code to transmit, via the data network, to the plurality of client computing devices, catalogue data representing a catalogue of items, wherein the catalogue data comprises at least one of brand categories and goods and services classification catalogues, wherein the processor is further controlled by the computer program code to select the catalogue data in accordance with a user specific data associated with a client computing device, wherein the user specific data comprises at least one of location data and social network data.

36-40. (canceled)

41. The server as claimed in claim 32, wherein the processor is further controlled by the computer program code to receive, via the data network, user generated item identification data representing the item, wherein the user generated item identification data comprises at least one of a keyword, image data, and social network interaction data, wherein the processor is further controlled by the computer program code to identify the item in accordance with a text recognition technique or an image recognition technique, and wherein the processor is further controlled by the computer program code to request, via the data network, the item identification data in accordance with the user generated item identification data.

42-47. (canceled)

48. The server as claimed in claim 32, wherein the processor is further controlled by the computer program code to syndicate, via the data network, the adjusted price request data, wherein the processor is further controlled by the computer program code to syndicate, via the data network, the adjusted price request data using a social network, wherein the processor is further controlled by the computer program code to calculate adjusted price offer probability data representing a probability of the offer of the adjusted price request, and wherein the adjusted price offer probability data is calculated in accordance with at least one of the adjusted price request, historical adjusted priced item price offer data, and a number of the plurality of offered price requests.

49-53. (canceled)

54. The server as claimed in claim 32, wherein the adjusted priced item price data comprises identification data uniquely identifying the adjusted priced item price, the identification data adapted for use in redeeming the adjusted priced item price, wherein the identification data comprises scannable identification data, wherein scannable identification data includes barcode data including at least one of 1-D and 2-D barcode data.

55-57. (canceled)

58. The server as claimed in claim 32, wherein the server is further adapted for receiving, via the data network, location data representing a location of a client computing device and offering a price in accordance with the discount or item price offer data.

59. The server as claimed in claim 32, wherein the adjusted price request data is at least one of lower price request data representing a plurality of lower price requests and higher price request data representing a plurality of higher price requests.

60. (canceled)
